(19) United States
(12) Patent Application Publication
(10) Pub. No.: US 2013/0045464 A1
(43) Pub. Date: Feb. 21, 2013

(54) DENTAL IMPLANT HAVING DIFFERENT SURFACE STRUCTURE REGIONS

(71) Applicant: Jost Lussi, Basel (CH)

(72) Inventor: Jost Lussi, Basel (CH)

(73) Assignee: Straumann Holding AG, Basel (CH)

(21) Appl. No.: 13/634,655

(22) PCT Filed: Mar. 31, 2011
(86) PCT No.: PCT/EP11/01614

§ 371 Date: Oct. 18, 2012

(30) Foreign Application Priority Data
Mar. 31, 2010 (EP) 10003573.2

(51) Int. Cl. A61C 8/00

(52) U.S. Cl. 433/174

(57) ABSTRACT

The invention relates to a dental implant comprising a shaft region (14) facing an apical end, comprising a base form that is substantially cylindrical or tapers down toward the apical end. The shaft region (14) is intended to be anchored in the bone of the patient in the implanted state. The dental implant further comprises a head region (12) adjacent to the shaft region (14) and facing a coronal end opposite the apical end. The shaft region (14) comprises an anchor region (20) disposed in the region of the apical end and a transition region (22) adjacent to the anchor region (20) and extending to the head region (12) in the coronal direction, wherein the boundary between the transition region (22) and the anchor region (20) extends 2 to 5 mm apical to the boundary between the head region (12) and the shaft region (14), and the surface structure of the transition region (22) is different from the surface structure of the anchor region (20).

The present invention relates to a dental implant as per claim 1, to a dental implant system, as per claims 12 and 13, comprising the dental implant, and also to a method as per claim 14 for producing the dental implant.

Dental implants fitted in the jaw bone, for example for securing an artificial tooth therein, have long been in use. Implants made of titanium have mainly been used to date. Titanium is biocompatible, has a sufficiently low modulus of elasticity and relatively high strength, and therefore meets the most important requirements of a dental implant.

Besides biocompatibility and mechanical properties, the bone integration properties of a dental implant are of great importance. Directly after the dental implant has been implanted in the jaw bone, it is held by what is called primary stability. Primary stability designates the mechanical retention of the implant. This mechanical retention is achieved using a thread, for example, but it can also be obtained by undercutting, clamping or friction. While this primary stability decreases over time, the jaw bone grows permanently onto the dental implant and forms a union with the latter. This union, referred to as osseointegration, provides what is called secondary stability, which corresponds to biological retention. The process of osseointegration should take place as rapidly as possible, in order to reduce the risk of the implant loosening and therefore possibly falling out.

To optimize the process of osseointegration, the dental implants commonly used at the present time often have a roughened shaft region. For example, particularly good osseointegration properties are obtained if the shaft region is mechanically roughened and is thereafter additionally etched.

A corresponding dental implant made from a metal, for example titanium, is disclosed in EP-A-0388576. According to the latter document, the surface is subjected to sand-blasting and is subsequently etched with a reducing acid. Above the bone limit, these dental implants are generally smooth or polished.

A dental implant made of titanium generally has a dark gray color and therefore differs from the natural color of the teeth. As a result, dental implants made of ceramic were proposed, the color of ceramic being able to be adapted to the natural color of the teeth.

To ensure optimal osseointegration, it was also proposed that the surface of dental implants made of ceramic be roughened. EP-A-1982670 describes a method for producing a topography on a dental implant that has a surface made of ceramic material. After mechanical roughening, the surface of the dental implant is etched by means of an etching solution containing hydrofluoric acid.

However, mechanical roughening of the surface, for example by sand-blasting, can cause structural defects, particularly on ceramic dental implants, and these defects can give rise to a loss of strength of the dental implant in the affected areas.

The object of the present invention is therefore to make available a dental implant which, on the one hand, has good properties in terms of primary and secondary stability in the bone and which, on the other hand, has a high degree of strength.

This object is achieved by a dental implant as per claim 1. Preferred embodiments are set forth in the dependent claims.

The dental implant of the present invention comprises a shaft region directed toward an apical end, with a basic form that is substantially cylindrical or that tapers like a cone in the direction toward the apical end. The shaft region is intended to be anchored, in the implanted state, in the bone of the patient. The dental implant further comprises a head region, which adjoins the shaft region and is directed toward a coronal end lying opposite the apical end.

According to the invention, the shaft region now comprises an anchor region, arranged in the area of the apical end, and a transition region, which adjoins the anchor region in the coronal direction and extends as far as the head region, wherein the boundary between transition region and anchor region extends by 2 to 5 mm in the apical direction from the boundary between head region and shaft region, or in the apical direction from the nominal bone level, and the surface structure of the transition region differs from the surface structure of the anchor region.

The boundary between transition region and anchor region preferably extends by 3 to 5 mm in the apical direction from the boundary between head region and shaft region, particularly preferably by 3 to 4 mm and most preferably by ca. 3.5 mm.

According to a preferred embodiment, the shaft region has a length of 4 to 16 mm, preferably of 6 to 16 mm, in the axial direction.

In particular, the surface structure can be described by a surface roughness.

The invention makes use of the knowledge that the surface structure, in particular the surface roughness, in the transition region can differ from that in the anchor region, without thereby greatly impairing the primary stability and the secondary stability.

According to the invention, it is thus possible to adapt the surface roughness in the different regions to the specific requirements of the respective region.

Of particular relevance, in terms of strength, is the area of the dental implant at which the limit between the bone, surrounding the dental implant, and the soft tissue (the so-called bone limit) comes to lie. This can be explained in terms of the fact that, in the event of a bending load, which corresponds to the main loading situation for a dental implant, the implanted dental implant forms a clamped cantilever. With clamped cantilevers of this nature, a force component acting at right angles to the longitudinal axis of the implant creates a moment, which grows continuously as far as the clamping. The maximum load thus occurs at the clamping, that is to say, in the case of a dental implant, at the height corresponding to the limit between bone and soft tissue.

According to the invention, the transition region is arranged in such a way that, in the implanted state, the limit between the bone, surrounding the dental implant, and soft tissue comes to lie at the height of the transition region. Since the transition region therefore comprises that area of the dental implant exposed to the greatest load in the implanted state, the strength of the dental implant is determined mainly by the strength of the transition region.

The arrangement, according to the invention, of the transition region ensures that the real bone limit always comes to lie in the transition region, even after a possible maximum bone regression of ca. 3 mm. The risk of the dental implant breaking is therefore effectively reduced, even assuming the greatest possible bone regression.

According to a preferred embodiment, the transition region has a uniform surface topography. There are therefore no uncontrolled surface defects. This further contributes to greatly reducing the risk of the dental implant breaking.

According to a particularly preferred embodiment of the dental implant, the anchor region is roughened more than the transition region. In this embodiment, the surface of the anchor region generally has a macro-structure, in particular a macro-roughness, as is obtainable in particular by sand-blasting. It has been shown that this macro-roughness promotes in particular the formation of primary stability. Said macro-roughness is superposed by a microstructure, in particular a micro-roughness, as is obtainable by etching, for example.

In said embodiment, the transition region preferably only has a micro-roughness. Therefore, according to this embodiment, there is no sand-blasting of the transition region, which process may cause structural defects. It has been shown that lack of macro-roughness in the transition region hardly impairs the primary stability. Moreover, the micro-roughness present in the entire shaft region favors the formation of a blood coagulum layer and, therefore, favors the incorporation of the bone and thus permits good secondary stability.

As has been stated above, the transition region according to the invention is designed in such a way or its height chosen in such a way that, in the implanted state, the bone limit, i.e. the limit between the bone, surrounding the dental implant, and soft tissue comes to lie in the transition region, even after possible maximum regression of bone.

Since, during implantation, the dental implant is generally embedded so deeply into the bone that the bone limit comes to lie at the height of the boundary between shaft region and head region, or indeed higher, the boundary between anchor region and transition region comes to lie, directly after implantation, at least 3 mm in the apical direction from the bone limit.

The risk of the dental implant breaking is therefore avoided even when the bone around the implanted dental implant regresses by the maximum extent, which is the case, for example, when there is a maximum bone regression of up to ca. 3 mm below the nominal or original bone limit. The stated heights of the transition region or of the shaft region ensure that the boundary between anchor region and transition region lies in each case below the real bone limit, i.e. even assuming the maximum bone regression. It is thus ensured, even in this situation, that the maximum stressing of the dental implant does not come to lie in the relatively strongly roughened anchor region. Preferably, the distance from the end of the anchor region facing toward the coronal end, or from the boundary between anchor region and transition region, to the real bone limit is in each case at least 0.5 mm.

According to the invention, the transition region extends as far as the coronal end of the shaft region. If a micro-roughness, obtainable by etching for example, is present in the transition region, the provision of secondary stability is promoted in this region, even if the dental implant is embedded relatively deeply in the bone of the patient.

In another preferred embodiment, the dental implant according to the invention is made of ceramic, since the described advantages of the invention come to bear especially in the case of ceramic.

As has been mentioned, preferably only the anchor region has a surface roughness obtainable by means of sand-blasting. In this respect, it is further preferred that the entire shaft region has a surface roughness obtainable by means of etching, preferably after the sand-blasting of the anchor region. In this way, a tailor-made surface of the dental implant or of the shaft region is obtained.

The head region is generally designed in such a way that it widens in the direction toward the coronal end. It is conceivable, for example, for the head region to widen in a cup shape. Alternatively, however, it is also conceivable for the head region to be substantially cylindrical.

In one embodiment, the shaft region of the dental implant has an outer thread on its jacket surface. In the implanted state, this outer thread engages in the bone of the patient and contributes especially to ensuring good primary stability directly after implantation. In addition, a larger surface area is generated in the shaft region or the anchor region and, in this way, osseointegration for the development of secondary stability is promoted.

In addition to the dental implant described above, the present invention also relates to a dental implant system comprising said dental implant, which is formed in one piece with an abutment.

Alternatively, a dental implant system is also conceivable that comprises the dental implant and an abutment separate from the dental implant. In this case, the abutment is generally mounted in a recess formed on the dental implant, or on a suitably formed support, with the aid of retaining means and secured against rotation about a longitudinal axis of the dental implant. This two-piece or multi-piece dental implant system permits a high degree of flexibility and easy handling of the individual components during implantation and when fitting the tooth prosthesis.

A further aspect of the invention concerns a method for producing a dental implant. This method comprises consecutive steps in which

a) only the anchor region is sand-blasted, and

b) the entire shaft region is etched.

In order to treat only the anchor region by sand-blasting, it is conceivable to mask the remaining area, i.e. the transition region and the head region of the dental implant. The mask is then removed and the dental implant, or the outer surface thereof, is etched in an acid bath.

The invention is explained with reference to the attached figures, in which:

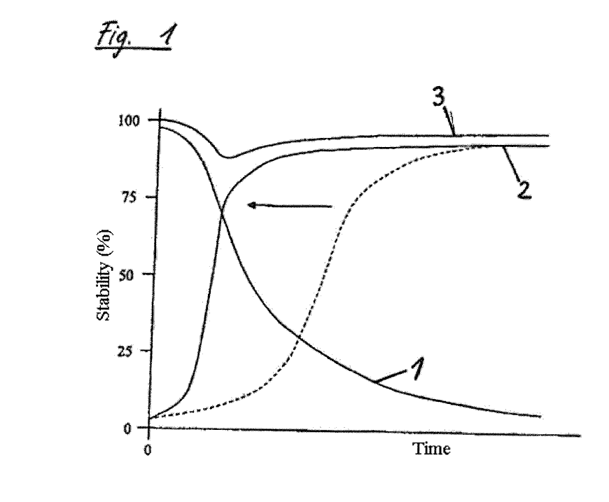

FIG. 1 shows a diagram with a profile of the primary stability and secondary stability over time, as can be obtained by the dental implant system of the present invention, and

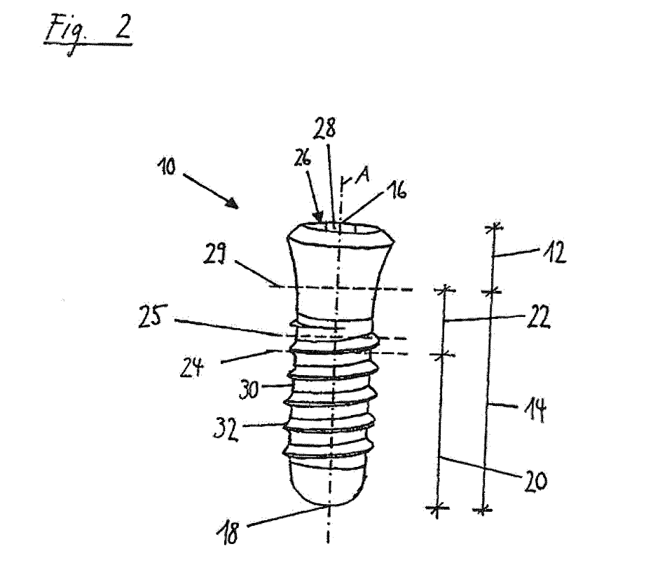

FIG. 2 shows a dental implant according to the present invention, comprising two regions having mutually different surface structures or surface roughnesses.

Graph 1 in FIG. 1 describes the development of the primary stability of a dental implant 10 in the bone over time, starting from the moment of implantation, while graph 2 describes the development of the secondary stability of the dental implant 10 over time, likewise starting from the moment of implantation. The development of the overall stability, i.e. the sum of primary stability and secondary stability, is described by graph 3. According to the invention, it has been found that, by suitable surface roughnesses in the transition region and in the anchor region, the primary stability and the secondary stability are very good even when the surface roughnesses in these regions differ from each other, without the strength of the dental implant being impaired to any appreciable extent.

FIG. 2 shows a dental implant 10 comprising a shaft region 14, with a basic form that is substantially cylindrical or that tapers in the direction toward the apical end, and a head region 12, which adjoins the shaft region 14 in the direction of the coronal end 16 and widens in a cup shape. In an alternative to the embodiment shown, it is also possible for the head region to be cylindrical and/or to be kept very short.

The surface of the head region 12 is intended to come into contact with the soft tissue of the patient in the implanted state and is generally smooth or polished. However, it is also possible to provide a special surface roughness in this region.

The shaft region 14 adjoins the head region 12 and extends from the latter as far as the apical end 18 of the dental implant 10. The shaft region 14 has a surface structure in the form of a surface roughness and is divided into two regions, namely an anchor region 20 directed toward the apical end 18, and a transition region 22 directed toward the head region 12 or the coronal end 16. The anchor region 20 thus extends from the apical end 18 of the dental implant 10 as far as a boundary 24. The transition region 22 adjoins the anchor region 20 directly at the boundary 24 and extends as far as the coronal end of the shaft region 14.

The boundary 24 extends in such way that, in the implanted state, it comes to lie in the apical direction from a bone limit 25 that arises, with maximum bone regression, during incorporation and also during subsequent use, as is explained below.

In the embodiment shown, the transition region 22 has a dimension of 4 mm measured in the axial direction A of the dental implant 10. The full dimension of the shaft region 14, likewise measured in the axial direction A of the dental implant 10, is 12 mm, hence the dimension of the anchor region 20, measured in the axial direction A, is 8 mm. This arrangement of the individual regions ensures that the bone limit 25 does not come to lie in the anchor region 20. Instead, with the chosen dimensions, the bone limit comes to lie in the transition region 22 even if, in accordance with ISO 14801, there is a maximum bone regression of 3 mm starting from the nominal bone limit 29. Moreover, as a result of the chosen heights of the transition region 20 and of the shaft region 14 or anchor region 22, the distance in the implanted state between the bone limit and the boundary 24 is always 1 mm, even with maximum bone regression of 3 mm.

The coronal end 16 of the dental implant 10 is provided with a recess 26, into which an abutment can be fitted.

With the aid of retaining means 28, which are formed in the recess 26, the abutment is mounted in a manner known per se and secure against rotation about the longitudinal axis A of the dental implant 10. However, the abutment can also be formed in one piece with the dental implant 10.

During implantation, the shaft region 14 is preferably embedded completely in the bone of the patient. Directly after the implantation, the implant is therefore surrounded by the bone up to a nominal bone limit 29. During the period of incorporation, the real bone limit, i.e. the actual boundary between bone and soft tissue, can shift as a result of bone regression. However, by virtue of the chosen design of the individual regions, the real bone limit comes to lie within the transition region 22 throughout the entire phase of incorporation of the implant.

On average, the bone regression for existing implant systems is 1 to 2 mm. As has been mentioned, ISO 14801 estimates a maximum regression of 3 mm starting from the nominal bone limit 29. FIG. 2 shows the bone limit that results from the maximum expected bone regression. As has been explained above, by virtue of the chosen heights of the transition region 22 and of the shaft region 14 or anchor region 20, the boundary 24 between anchor region 20 and transition region 22 extends below, i.e. in the apical direction from, the bone limit 25 resulting from the maximum expected bone regression. The distance between said bone limit 25 and the boundary 24 is preferably ca. 0.25 mm to 1 mm, particularly preferably ca. 0.5 mm.

The anchor region 20 and the transition region 22 each have a surface structure, and these surface structures differ from each other. In order to meet the desired requirements in respect of strength and the development of secondary stability and primary stability, the anchor region 20 is generally made rougher than the transition region 22. For this purpose, only the anchor region 20 is roughened by means of sand-blasting in a first step. After the anchor region 20 has been sand-blasted, the entire shaft region 14, i.e. both the anchor region 20 and also the transition region 22, is treated by means of etching. The transition region 22 is thus treated only by etching, whereas the surface structure of the anchor region 20 is additionally treated by a previous sand-blasting. Thus, the surface structure of the transition region 22 corresponds to a microstructure obtained by etching, whereas the surface structure of the anchor region 20 corresponds to a macrostructure than has been obtained by sand-blasting and that has a superposed microstructure obtained by etching. In addition to said method, further alternatives are conceivable for generating surface structures. Thus, a surface structure can also be obtained by grinding, for example.

Since the shaft region 14 is treated only by etching in the transition region 22, it has a regular surface topography. This regular surface topography ensures a constant strength of the dental implant 10 in the area of the transition region 22. Structural defects that can be caused by the sand-blasting are thus largely absent in the transition region 22. Alternative surface-structuring methods are conceivable in which a regular surface topography is obtained. Suitable methods can be easily applied by a person skilled in the art who has acquired knowledge of the present invention.

As has been mentioned, the transition region 22 is designed such that, even in the event of strong regression of the effective bone limit, any load peaks occasioned by an external force always fall in the transition region. Therefore, a moment that occurs in the event of loading can be taken up by the dental implant, without the latter being damaged or even breaking off.

For rapid development of primary stability, the dental implant also has an outer thread 32, which is arranged on an outer jacket surface 30 and which, in the implanted state, engages in the bone of the patient. According to the embodiment shown in FIG. 2, most of the outer thread is arranged inside the anchor region 20.

For rapid development of secondary stability, the microstructure obtained by the etching promotes the formation of a blood coagulum layer on the surface of the shaft region (cf. also FIG. 1).

As regards the production of the macro-roughness or micro-roughness for a dental implant made of ceramic, the sand-blasting is preferably carried out with aluminum oxide particles, in particular particles of modified aluminum oxide, for example corundum grains with a mean grain size in the range of ca. 0.1-0.5 mm, preferably ca. 0.25 to 0.5 mm. Moreover, zirconium oxide particles or other materials can also be used as blasting agent. The etching for said dental implants is preferably carried out by means of a solution containing hydrofluoric acid, particularly at a temperature of at least 70° C.

Furthermore, it is also conceivable to form more than two different surface structures on the shaft region 14, in order to satisfy further requirements concerning the primary stability/secondary stability or strength of the dental implant.

1. A dental implant comprising a shaft region directed toward an apical end, with a basic form that is substantially cylindrical or that tapers like a cone in the direction toward the apical end, which shaft region is intended to be anchored, in the implanted state, in the bone of the patient, and comprising a head region, which adjoins the shaft region and is directed toward a coronal end lying opposite the apical end, wherein the shaft region comprises an anchor region, arranged in the area of the apical end, and a transition region, which adjoins the anchor region in the coronal direction and extends as far as the head region, wherein the boundary between transition region and anchor region extends by 2 to 5 mm in the apical direction from the boundary between head region and shaft region, and the surface structure of the transition region differs from the surface structure of the anchor region.

2. The dental implant as claimed in claim 1, wherein the shaft region has a length of 4 to 16 mm in the axial direction (A).

3. The dental implant as claimed in claim 1, wherein the surface structure is a surface roughness.

4. The dental implant as claimed in claim 1, wherein the transition region is arranged such that, in the implanted state, the limit between the bone, surrounding the dental implant, and soft tissue comes to lie in the transition region.

5. The dental implant as claimed in claim 1, wherein the transition region has a uniform surface topography.

6. The dental implant as claimed in claim 1, wherein the anchor region is roughened more than the transition region.

7. The dental implant as claimed in claim 1, wherein the dental implant is made of ceramic.

8. The dental implant as claimed in claim 1, wherein only the anchor region has a surface structure obtained by means of sand-blasting.

9. The dental implant as claimed in claim 1, wherein the shaft region has a surface structure obtained by means of etching.

10. The dental implant as claimed in claim 1, wherein the shaft region has an outer thread.

11. The dental implant as claimed in claim 1, wherein the head region widens in the direction toward the coronal end.

12. A dental implant system comprising a dental implant as claimed in claim 1, which dental implant is formed in one piece with an abutment.

13. A dental implant system comprising a dental implant as claimed in claim 1, and an abutment separate from the dental implant.

14. A method for producing a dental implant as claimed in claim 1, wherein the method comprises consecutive steps in which
a) only the anchor region is sand-blasted, and
b) the entire shaft region is etched.

15. The dental implant as claimed in claim 1, wherein the shaft region has a length of 6 to 16 mm in the axial direction (A).
